(19) United States
(12) Patent Application Publication
(10) Pub. No.: US 2020/0036327 A1
(43) Pub. Date: Jan. 30, 2020

(54) UPCONVERTED HYBRID CONCENTRATOR SOLAR ENERGY DEVICE

(71) Applicant: Reginald Parker, Smyrna, GA (US)

(72) Inventor: Reginald Parker, Smyrna, GA (US)

(21) Appl. No.: 16/588,290

(22) Filed: Sep. 30, 2019

Related U.S. Application Data
(63) Continuation-in-part of application No. 15/480,622, filed on Apr. 6, 2017.
Application No. 15/480,622 is a continuation-in-part of application No. 13/019,021, filed on Feb. 1, 2011, now abandoned.
(60) Provisional application No. 62/739,640, filed on Oct. 1, 2018.

(51) Int. Cl. H02S 40/22; G02B 19/00; G02B 27/12; G02B 5/08; H02S 40/20; H02S 20/32

(52) U.S. Cl. CPC H02S 40/22; G02B 19/0042; G02B 19/0009; H02S 20/32; G02B 5/08; H02S 40/20; G02B 27/123

(57) ABSTRACT

An apparatus may upconvert infrared-visible energy passed by a spectral separator to a reflector, the reflector reflecting the infrared-visible energy to an upconverter film for combination with a visible-ultraviolet energy output of a spectral separator at a photovoltaic converter to electricity. The apparatus generates electricity through separating the infrared (IR) region and light within the visible and ultraviolet (UV) regions, then converting the infrared (IR) regions to light within the visible and UV regions, then converting all visible and UV light into electricity. The apparatus uses polychromatic light concentration (typically from, the sun), spectral separation, IR to visible light conversion, and photoelectric generation.

This application is a continuation-in-part of U. S. patent application Ser. No. 15/480,622 filed Apr. 6, 2017, which is a continuation-in-part of U. S. Patent Application Serial No. 13/019,021 filed Feb. 1, 2011 and this application claims the right of priority to U.S. Provisional Patent Application Ser. No. 62/739,640 filed Oct. 1, 2018, the subject matter of each of the above-identified patent applications is incorporated by reference herein as to their entire subject matter.

### TECHNICAL FIELD

This invention generally relates to an apparatus for efficiently using solar radiation for generating electricity.

### BACKGROUND

The following discussion of the solar energy arts should not be construed as an admission that the subject matter of the discussion is known to others.

Efficient and strategic concentration, separation, collection and use of radiant energy is useful in a number of applications and is of particular value for devices that convert solar energy to electrical energy, Concentrator technology can multiply the, surfs energy as little as two times the suns energy and as much as 1500 times the suns energy or more. Concentrator technology is achieved by focusing the sun's power onto a smaller platform. As an example, a 32 cm by 32 cm Fresnel lens can focus the sun's energy onto a 1 cm by 1 cm surface. In doing so, the surface will experience the power of just over 1,000 times the power of the sun (or 1,000 suns).

Applications for concentrator technology may be for concentrated photovoltaic technology (CPV) or for concentrated solar thermal (CST) technology. CPV uses the concentrated light onto a solar cell. An increase in solar radiation increases the production of photocurrent; however, there is a concurrent decrease in overall power due to the addition of heat found in IR energy. CST heats a working fluid which either directly or indirectly drives a turbine producing electricity and/or utility scale steam. The majority of the heating of the working fluid is derived from the IR portion of the spectrum. Thus, CPV and CST are promising technologies requiring further development; however, IR light reduces the efficiency of CPV and Visible light is ineffectual in CST.

Large-scale light concentrators for obtaining solar energy typically include a set of opposed, curved mirrors, with a Cassegrain arrangement, as an optical system for concentrating light onto a receiver that is positioned at a focal point. A few examples employing the Cassegrain model are U.S. Pat. No. 5,979,438 and U.S. Pat. No. 5,005,958 incorporated by reference herein in their entirety.

A more recent development may provide a more compact collection apparatus, planar concentrators. Planar concentrators similarly employ primary and secondary curved mirrors with a Cassegrain arrangement, separated by a dielectric optical material, for providing high light flux concentration.

Other examples of light concentrators include the use Fresnel lens as an optical system for concentrating light onto a receiver that is positioned at a focal point. A few examples employing the Fresnel model are U.S. Pat. No. 4,069,812, U.S. Pat. No. 4,088,120 and U.S. Pat. No. 6,399,874, incorporated by reference in their entirety.

Some types of solar energy systems operate by converting light energy to heat. In various types of flat plate collectors and solar concentrators, concentrated sunlight heats a fluid traveling through the solar cell to high temperatures for power generation. An alternative type of solar conversion mechanism, more adaptable for use in thin panels and more compact devices, may use photovoltaic (PV) materials to convert sunlight directly into electrical energy.

As is well known, sunlight is highly polychromatic. Sunlight contains broadly distributed spectral content at all frequencies, ranging, for example, from ultraviolet (UV), through visible, and infrared (IR) wavelengths, each wavelength having an associated energy level, typically expressed in terms of electron-volts (eV). Due to differing band-gap characteristics between. materials, the response of any one particular photovoltaic material depends upon the incident wavelength. Photons having an energy level below the band gap of a material slip through the material. For example, it is to be noted that red light photons (nominally around 1.9 eV) are not absorbed by high band-gap semiconductors and energy from violet light photons (nominally around 3 eV) is wasted as heat in a low band-gap semiconductor.

One strategy for obtaining higher efficiencies from photovoltaic materials is to form a stacked photovoltaic cell, also sometimes termed a multi-function photovoltaic device. These devices are formed, by stacking multiple photovoltaic cells on top of each other. With such a design, each successive photovoltaic cell in the stack, with respect to the incident light source, has a lower band-gap energy due to the depth of the stack. In a simple stacked photovoltaic device, for example, an upper photovoltaic cell, consisting of gallium arsenide (GaAs), captures the higher energy of blue light, A second cell in the stack, of gallium antimonide (GaSb), converts the lower energy infrared light into electricity. One example of a stacked photovoltaic device is given in U.S. Pat. No. 6,835,888 entitled “Stacked Photovoltaic Device” to Sano et al., incorporated by reference herein in its entirety.

While stacked photovoltaics can provide some measure of improvement in overall efficiency, these multi-layered devices can be costly to fabricate. There can also be restrictions on the types of materials that can be stacked together on top of each other, making it difficult for such an approach to prove economical for a broad range of applications. Another approach is to separate the light according to wavelength into two or more different spectral portions, and to concentrate each portion onto an appropriate photovoltaic receiver device, with two or more photovoltaic receivers arranged side by side. With this approach, photovoltaic device fabrication is simpler and less costly, and a wider variety of semiconductors can be considered for use. This type of solution requires supporting optics for both separating light into suitable spectral components and concentrating each spectral component onto its corresponding photovoltaic surface.

One proposed solution for simultaneously separating and concentrating light at sufficient intensity is described in a paper entitled “New Cassegrainian PV Module using Dichroic Secondary and Multijunction Solar Cells” presented at an International

Conference on Solar Concentration for the Generation of Electricity or Hydrogen in May, 2005 by L. Fraas, J. Avery, H. Huang, and E. Shifman. In the module described, a curved primary mirror collects light and directs this light toward a dichroic hyperbolic secondary mirror, near the focal plane of the primary mirror. IR light is concentrated at a first photovoltaic receiver near the focal point of the primary mirror. The secondary mirror redirects near-visible light to a second photovoltaic receiver positioned near a vertex of the primary mirror. In this way, each photovoltaic receiver obtains the light energy for which it is optimized, increasing the overall efficiency of the solar cell system.

While the approach shown in the Fraas et al. paper advantageously provides spectral separation and concentrates light using the same set of optical components, there are some significant limitations to the solution that it presents. A first problem relates to the overall losses due to obstruction, as were noted earlier. As another problem, the apparatus described by Fraas et al. has a limited field of view of the sky because it has a high concentration in each axis due to its rotational symmetry. Yet another drawback relates to the wide bandwidths of visible light provided to a single photovoltaic receiver. With many types of photovoltaic materials commonly used for visible light, an appreciable amount of the light energy would still be wasted using such an approach, possibly causing excessive heat.

Dichroic surfaces, such as are used for the hyperbolic mirror in the solution proposed in the Fraas et al. paper, provide spectral separation of light using interference effects obtained from coatings formed from multiple overlaid layers having different indices of refraction and other characteristics. In operation, dichroic coatings may reflect and transmit light as a function of incident angle and wavelength. As the incident angle varies, the wavelength of light that is transmitted or reflected by a dichroic surface also changes. Where a dichroic coating is used with incident light at angles beyond about +/− 20 degrees from normal, undesirable spectral effects can occur, so that spectral separation of light, due to wavelength differences, is compromised at such higher angles.

There have been a number of light collector solutions employing dichroic surfaces for spectral splitting. For example, in an article entitled “Spectral Beam Splitting. Technology for Increased Conversion Efficiency in Solar Concentrating Systems: A Review”, available online at www.sciencedirect.com, authors A. G. Imenes, and D. R. Mills provide a survey of solar collection systems, including some using dichroic surfaces. For example, the description of a tower reflector (FIG. 24 in the Imenes and Mills article) shows one proposed solution that employs a curved dichroic beam splitter as part of the optics collection system. High incident angles of some portion of the light on this surface could render such a solution as less than satisfactory with respect to light efficiency. Similarly, U.S. Pat. No. 4,700,013 entitled “Hybrid Solar Energy Generating System”? to Soule describes the use of a dichroic surface as a selective heat mirror, incorporated by reference in its entirety.

There are inherent problems with dichroic surface shape and placement for light focused from a parabolic mirror. A flat dichroic surface positioned near the focal region of a parabolic reflector would exhibit poor separation performance for many designs. constraining the dimensions of a light collection system. A properly curved dichroic surface, such as a hyperbolic curved surface, can be positioned at or near the focal region, but may obstruct some portion of the available light, as noted earlier.

Conventional approaches for light concentration have been primarily directed to rotationally symmetrical optical systems using large-scale components. However, this approach may not yield satisfactory solutions for smaller solar panel devices. There exists a need for an anamorphic light concentrator that can be formed on a transparent body and fabricated in a range of sizes, where the light concentrator design allows it to be extended in a direction orthogonal to the direction of its highest optical power, whether extended linearly or extended along a curve.

Against obstacles such as poor dichroic surface response, conventional approaches have provided only a limited number of solutions for achieving, at the same time, both good spectral separation and efficient light flux concentration of each spectral component. The Fresnel model may be used to remove those issues. A flat dichroic surface may be used to separate light to allow for efficient separation. Further recent developments has shown up-conversion as a method to increase the efficiency of both PV by 44% and CPV by 19.7%. The work concentrates on reshaping the solar spectrum to enable solar chips to be more effective.

### SUMMARY OF THE EMBODIMENTS

It is an object of the present invention to advance the art of light collection, spectral separation, and IR conversion for energy collection. With this object in mind, the present invention provides an apparatus for obtaining radiant energy from a polychromatic radiant energy source, the apparatus comprising: a) a concentrator, b) spectral separator, c) a photovoltaic device, d) a reflector, and e) an IR converter. The IR converter can be formed from lead sulfide (PbS)/rubrene thin films.

It is an aspect of the embodiments that an apparatus provides concentration of light with its subsequent spectral separation into at least two spectral bands, and energy conversion onto a single collector. The single collector directly produces electrical energy through conversion of visible and UV light bands into electricity. Additionally, it is an aspect of the embodiments that associated apparatus reduces losses from obstruction, common to systems using the Cassegrain model.

### DESCRIPTION OF ILLUSTRATION

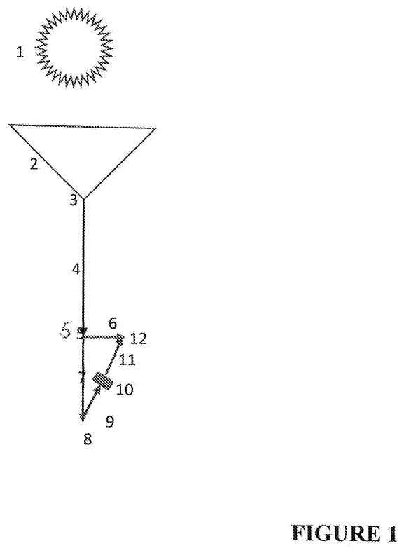

FIG. 1 is a schematic diagram of an upconverted hybrid concentrator solar energy device. Electromagnetic radiation (1), for example, from the sun transmits light onto a converging Fresnel lens (2) which transmits light onto a diverging Fresnel lens (3). Fresnel lens (2). All elements shown below the Fresnel lens (2) may be moved as the sun moves across, the sky in the various seasons of the year via a motor system controlled according to a sun calendar (not shown but described in priority patent applications). A computer processor and associated software for motor control and the motor for moving the Fresnel lens to face the sun are not shown. A similar motor system is known, for example, from the field of telecommunications transmission and reception, for example, satellite tracking motor control systems with a difference being that the present system may track the travel of the sun (1) or other source of electromagnetic radiation if it is a moving source, for example, tracking the sun as it travels across the sky.

As the light exits the diverging Fresnel lens (3), the light is collimated at collimator (4). The collimated light output of collimator (4) is directed to a dichroic lens (5) which separates the light into visible and ultraviolet (UV) light (6), as well as infrared radiation (IR) (7). The infrared light is reflected at reflector (8) and, redirected (9) to an upconverter thin film (10). The upconverter thin film for up-conversion of infrared to visible-ultraviolet may comprise lead sulfide (PbS)—rubrene thin film. The upconverter film 10 may be located anywhere between one millimeter of reflector (8) and photovoltaic converter 12. The upconverted light (11), now in the visible and ultraviolet spectrum is received at a photovoltaic converter (12) for converting visible and ultraviolet light into electricity for residential or commercial use. Likewise, the visible and UV light (6) is directed to the photovoltaic converter (12). The photovoltaic converter (12) produces electrical energy directly from the visible and ultraviolet spectrum received via dichroic lens 5 and via upconverter film 10 which upconverts the infrared spectrum received at reflector 8 to visible/ultraviolet light at photovoltaic converter (12). The upconverter film (10) permits the conversion of infrared light output as redirected infrared as well as visible and ultraviolet light energy (6) to electric energy without having to treat infrared energy separately from visible and ultraviolet energy.

A thorough description of, a high efficiency hybrid, solar energy device is found in priority U.S. patent application Ser. No. 15/480,622 (the '622 patent application) filed Apr. 6, 2017 and is incorporated herein in its entirety especially including FIGS. 5 through 11 and FIGS. 13 through 15. Preferably, the Fresnel lens 620 shown in FIG. 6 comprises the converging Fresnel lens (2) and the diverging Fresnel lens (3) in the form of a circular domed portion and a flat square portion for focusing received light on collimator 615 (collimator (4) herein). The dome-shaped lens portion combines with the square flat lens portion of approximately 400 mm by 400 mm such that the circular domed portion has a circular footprint on the flat square portion having a diameter in a range between 250 mm to 300 mm with 283 mm a preferred value. FIG. 14 of the '622 patent application shows a power of detector versus angle of incidence or degree by a factor of two and the detector is moved by the above-described motor (not shown) to a position of best focus on the collimator (4) where a ninety percent power on detector is measured between 0° and eight degrees angle of incidence.

Thus, there has been described a hybrid solar concentrator which separates the infrared energy from the polychromatic energy of the sun and upconverts the infrared energy to visible and ultraviolet energy (6) output of dichroic lens (5) to electricity.

What I claim is:

1. Apparatus for obtaining radiant energy from a polychromatic radiant energy source, the apparatus comprising:
a) a concentrator;
b) a spectral separator,
c) a photovoltaic device,
d) an IR reflector, and
e) an IR-Visible converter.

2. The apparatus of claim 1 wherein the concentrator comprises a converging Fresnel lens.

3. The apparatus of claim 1 wherein the concentrator comprises a diverging Fresnel lens.

4. The apparatus of claim 1 wherein the concentrator comprises a converging and a diverging Fresnel lens in the form of a dome-shaped portion having a circular footprint on a square flat lens portion.

5. The apparatus of claim 1 comprising a collimator for receiving light from the concentrator and passing the collimated light to the spectral separator.

6. The apparatus of claim 1 wherein the spectral separator comprises a dichroic lens.

7. The apparatus of claim 1 further comprising a motor system for moving said apparatus to follow a source of electromagnetic radiation.

8. The apparatus of claim 1 wherein the infrared-visible converter comprises an upconverter film for converting infrared-visible energy reflected by the infrared reflector to visible-ultraviolet energy for photo-voltaic conversion.

9. The apparatus of claim 1 wherein the infrared-visible converter comprises a lead sulfide/rubrene thin film.
